(19) United States
(12) Patent Application Publication
(10) Pub. No.: US 2025/0327436 A1
(43) Pub. Date: Oct. 23, 2025

(54) UNDERWATER CURRENT TURBINE USING AUTOMATIC BLADE PITCH POSITIONING

(71) Applicant: Narsimhan JAYARAM, Patterson Lakes, Victoria (AU)

(72) Inventor: Narsimhan JAYARAM, Patterson Lakes, Victoria (AU)

(21) Appl. No.: 18/855,334

(22) PCT Filed: Jan. 7, 2023
(86) PCT No.: PCT/AU2023/050005

§ 371 Date: Oct. 9, 2024

(30) Foreign Application Priority Data
Apr. 10, 2022 (AU) 2022900941

(51) Int. Cl. F03B 17/06; F03B 3/14; F03B 11/02; F03B 11/06; H02K 7/116; H02K 7/18; H02K 49/10

(52) U.S. Cl. CPC F03B 17/06; F03B 3/14; F03B 11/02; F03B 11/06; H02K 7/116; H02K 7/1823; H02K 49/106; F05B 2260/4031

(57) ABSTRACT

This present invention relates to a method of recovering the forward momentum of an underwater or surface current, wind velocity and waves referred to a renewable energy and converting their kinetic energy to electrical energy or potential energy by a pumping system by the use of a cross flow vertical axis turbine with automatic turbine blade pitch positioning. Energy in the form of coastal surf waves is also a source of energy that can be recovered in useful form.

### FIELD OF INVENTION

This present invention relates to a method of recovering the forward momentum of an underwater or surface current, wind velocity and waves referred to a renewable energy and converting their kinetic energy to electrical energy or potential energy by a pumping system by the use of a cross flow vertical axis turbine with automatic turbine blade pitch positioning. Energy in the form of coastal surf waves is also a source of energy that can be recovered in useful form.

By generating a rotary motion within the workings of the system, the use of this rotary motion can drive a set of permanent magnets surrounded by a conductor and there by inducing an electrical voltage/current in it or by pumping a liquid to a higher plane thereby generating a potential energy recovery system.

### PRIOR ART

There are literally around a 1000's of designs for ocean energy conversion devices and nearly all of them use the principle of buoyancy in their design. The beave motion obtained by a passing wave if converted into entire direct electric energy or used to pump a liquid to a higher plane.

There does not seem to exist a device that extracts the kinetic energy available of the traveling wave or uses the wave velocity in their design.

The IRENA, the International Renewable Energy Agency, in its Ocean Energy Report 2014 cites on page 19 sec 3.2 the type of hydrokinetic tidal stream conversion systems and the majority of these devices uses either
1. Horizontal Axis Axial flow turbine
2. Vertical Cross flow turbines

In the case of 1. above, the blades spins around the horizontal axis very similar to a wind turbine and these systems require a large seawater depth to accommodate the diameter of the turbine and needs it to be placed within the ocean current stream. Incoming flow passes the turbine blades in parallel with its axis and the rotation is based on the airfoil geometry causing lift and hence the rotation.

In the case of 2. above, the incoming flow causes the blades to spin around the vertical axis of the turbine. This again uses the airfoil geometry of the blades to generate lift causing a torque, creating a rotation of the vertical axis. This again will require it to be placed along an ocean current stream and in deep waters.

U.S. Pat. No. 7,279,803 B1 describes an axial flow turbine where the flow is parallel to the axis of rotation.

European Patent No EP 1467092A3 describes a blade pitch mechanism but it relates to the axial underwater current turbine.

US Patent No: 2015/0035279 A1 describes a Wave Energy Conversion System that uses the principles of buoyancy in its energy conversion mechanism.

U.S. Pat. No. 7,911,074 B2 describes a Tapered Helical Auger Turbine to convert the hydrokinetic energy into electrical energy. The rotation of the turbine is in the horizontal plane and has a scroll profile that causes the rotation. The blade profile is complicated in its build and is like a helical rotor of a helical rotor pump of an ‘auger’ of a mixer.

U.S. Pat. No. 4,184,212 describes again a helical rotor device and it use in the production of hydrogen for further use.

U.S. Pat. No. 8,624,417 B2 describes a system whereby a turbine is placed in a container and uses the wave angle to introduce seawater into it.

Australian Patent no 2017100917 describes a system where the turbine blades present a different angle of attack to the travelling medium creating a differential area on another side of an opposing quadrant. However, the blade area presented around the central blade support shaft is symmetrical and as such the rotational torque around the blade axis itself would be same and not produce any rotative torque. This also describes a system whereby the blade is fixed with equal areas around a blade shaft and is rotated by means of an actuator. The actuator force thus will also need to compensate for the force acting on the lower half of the blade area. In another form a set of hinges holds a blade that is free to rotate on a shaft, which is provided with several pins and that restricts the rotational motion of the hinged blade. This invention contains a number of moving parts ie the hinges, which is directly exposed to the environment and as such more prone to failure.

The present invention intends to overcome these deficiencies and a novel turbine design is presented.

The changing of the blade angle of attack is the essential feature of this invention along with a means to provide for different areas exposed to the directional flow of current and is achieved by rotating the blades such that it presents a very low impact area to the wave on one side while maximizing the area in the opposite quadrant.

The rotation of the blades itself is achieved by presenting a differential area across the blade support shaft. The blade area around its own axis is asymmetrical, with one segment having a larger area than the other around the axis of its support shaft, thus a differential load acts on the blade itself causing its rotation along its own axis.

Then, one quadrant of the blades projects the full blade area while the blades in the other quadrant present a much lower area and the difference in the kinetic energy ensures that the rotary motion is maintained.

Thus, two sets of differential areas are required to produce a rotation along the primary vertical axis that in turn rotates a permanent magnet generator via several or one speed increasing gearbox.

The entire assembly is provided with suitable mechanical seals to allow it to operate underwater.

In another form of the invention, flow accelerator is fitted in front of the current turbine and its intent is to accelerate the fluid flow to the blade.

As the power of the current turbine (500) is governed by the basic equation

$$P = 1 / 2 \times Rho \times A \times V 3$$

where;

| | | | |
|---|---|---|---|
| a. | P: | Power, watts | |
| b. | Rho: | Density of fluid: | kg/m3 |
| c. | A: | Area of Blade: | m2 |
| d. | V: | Fluid Velocity: | m/s |

It can be readily seen that given a constant density the power varies directly with the area and cubic with the velocity. Hence to increase power either the blade area can be increased or the velocity. Given the fact that the power is cubic function of velocity, this invention intends to accelerate the velocity entering a ‘flow enhancer’ buy gradually reducing the area of flow, such that at a smaller area the forward velocity is increased.

Conventional underwater wind turbines mimic the geometry of the wind turbine and to increase the power large diameter shrouds are required, mostly impractical and requires deep water installation sites. With the invention mentioned here the shallow body of water is adequate to install the flow enhancer.

### DETAILED DESCRIPTION

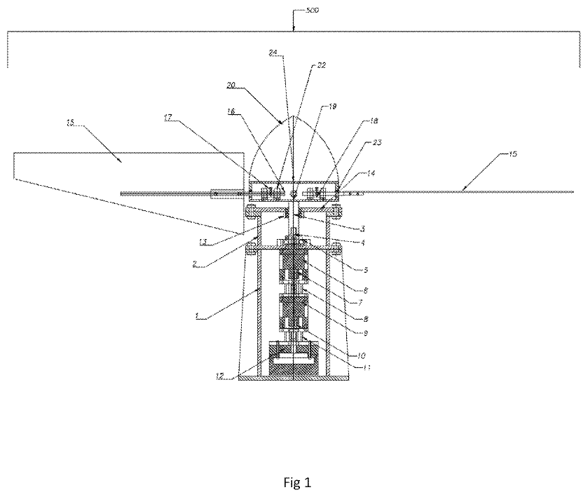

### Reference Will Now be Made to the FIG. 1.

FIG. 1 represents the embodiment of the invention and is a section assembly drawing which shows the key features of the device.

The current turbine (500) comprises the primary casing (1) which contains the permanent magnet generator (12) which is connected to a speed increasing gearbox (9) by the intermediate shaft (10) and centralized with the support head (11). The planetary gearbox (9) is connected to another speed increasing gearbox (6) via intermediate shaft (7). The output shaft of the speed increasing gearbox (6) is fitted with a secondary shaft (4) and the primary shaft (3) and connected to a thrust block (5) that supports the loads generated.

The primary shaft (3) connects to the torque disc (19) which hold components for supporting the blades (15).

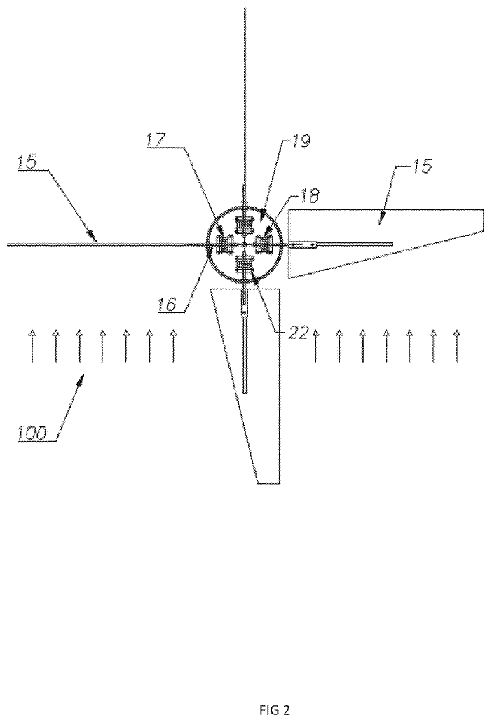

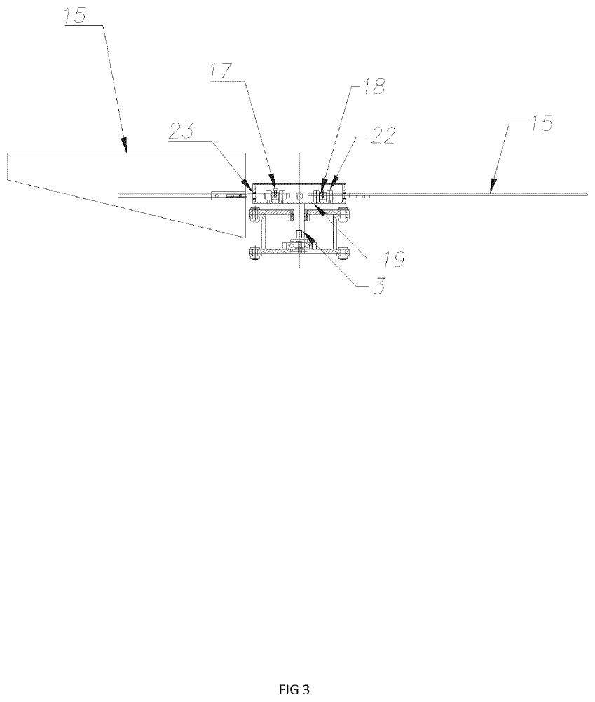

### Reference Will Now be Made to FIG. 2 and FIG. 3

FIG. 2 represents the plan and front section view of the main rotating assembly.

To the torque disc (19) are attached several bearing housings (22) that support the blade support shaft (16) which in turn holds the blade (15) rigidly in place. Torque transfer stud (17) is fixed onto the blade support shaft (16) and allows for a predetermined rotation angle of the blade support shaft (16). The torque transfer stud (17) rests in front of a torque transfer block (18) that is fixed onto the torque disc (19). Blade shaft seal (23) is shown.

The direction of the current flow (100) is shown.

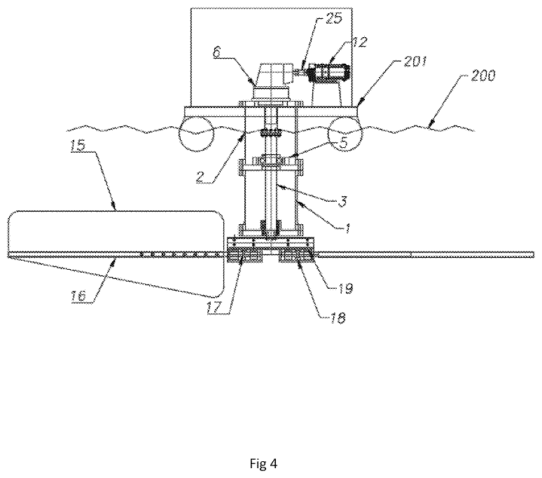

### Reference Will Now be Made to FIG. 4

This fig shows the front section view of another preferred embodiment of the invention.

Here the floating body (201) houses the permanent magnet motor (12) along with the gearbox (6) and this assembly floats on top of a body of water like a river or a tidal stream.

The bearing thrust block (5) supports the primary shaft (3) which has the torque plate (19) along with the blade support shaft (16) and the blade (15).

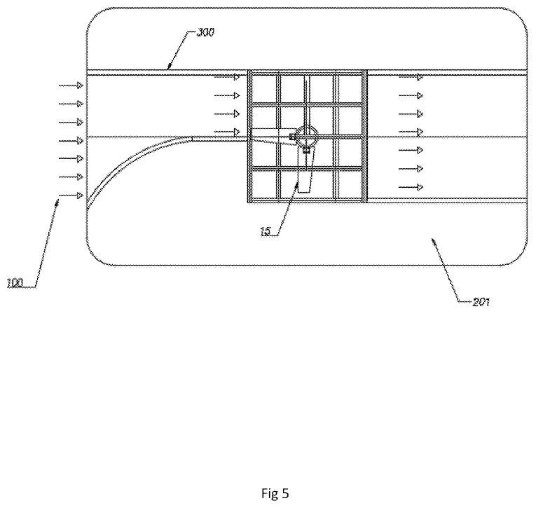

### Reference Will Now be Made to FIG. 5

This figure shows the plan view of the preferred embodiment of the invention that is fitted with a flow accelerator (300).

The floating body (201) houses the accelerator (300) and it is intended to accelerate the velocity of the flow (100) such that there is an increase at the blade (15).

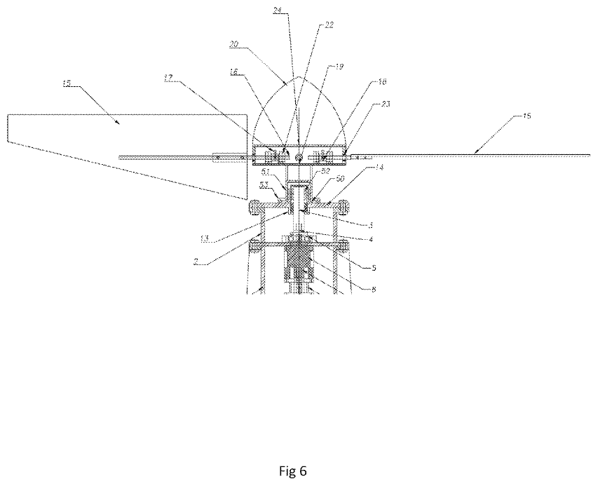

### Reference Will Now be Made to FIG. 6

This figure shows the arrangement of the magnetic coupling arrangement.

Permanent Magnets (52) are placed on the primary shaft (3) and to the torque plate drive collar (51) and is supported by the independent thrust bearing (53). A containment shell (50) is placed in between the permanent magnets (52) on the drive collar (51) and the primary shaft (3).

The magnetic attractive flux between the permanent magnet (52) on the primary shaft (3) and the drive collar (51) drives the primary shaft (3) when the torque plate (19) is subject to a rotational torque.

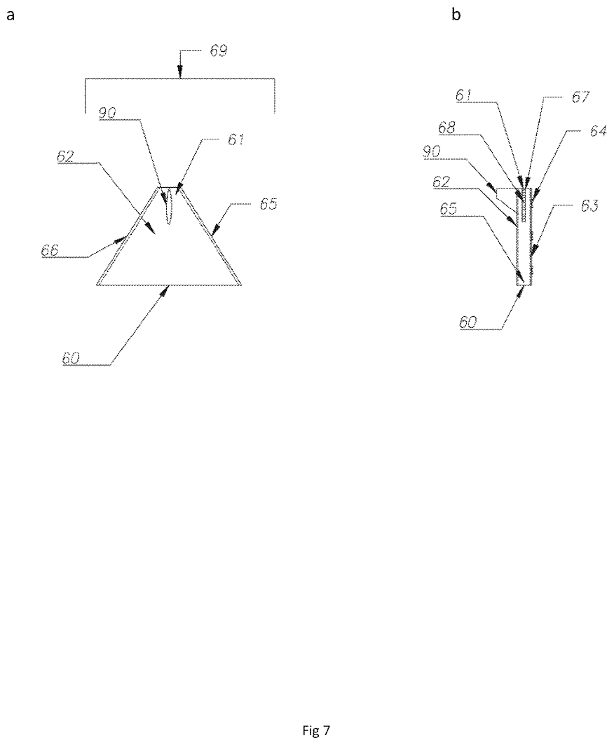

### Referring to FIG. 7.

This fig shows the plan and the side elevation of the Flow Enhancer (69).

The Flow Enhancer (69) is made of a material suited to the corrosive nature of the offshore marine environment and can also be suitably painted or coated to accord it protection.

The Entrance (60) allows for a volume of fluid into the Flow Enhancer (6) and this fluid leaves the Flow Enhancer (69) via the Exit (61). As it is reducing the cross-sectional area, the flow entering is accelerated through the length of the Flow Enhancer (69).

The Flow Enhancer (69) comprises a Top Plate (62) and a Bottom Plate (63), which in certain embodiment of the invention can be the Top Deck (12) of the Hull (1). Side covers are provided by the LHS Side Plate (66) and the RHS Side Plate (65) and thus forms an enclosed volume.

To the RHS Side Plate (65) is cut a Slot (67) and this is provided with a rubber or flexible Rubber Curtain (68).

In another embodiment of the invention, the RHS Side Plate (65) is not provided with a Slot (67) nor the Rubber Curtain (68) and the position of the CFITG (5) is placed further back to the stern, such that the Blades (118) do not intersect with the Flow Enhancer (69).

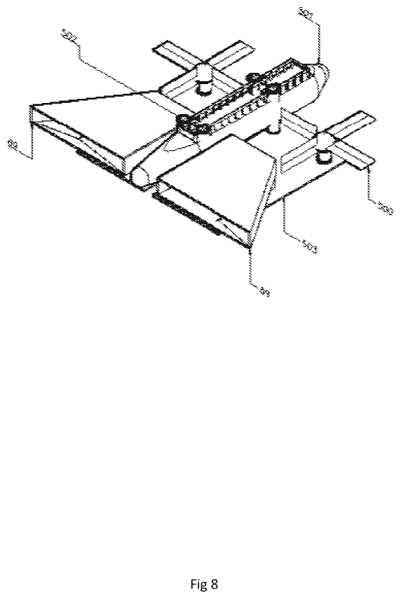

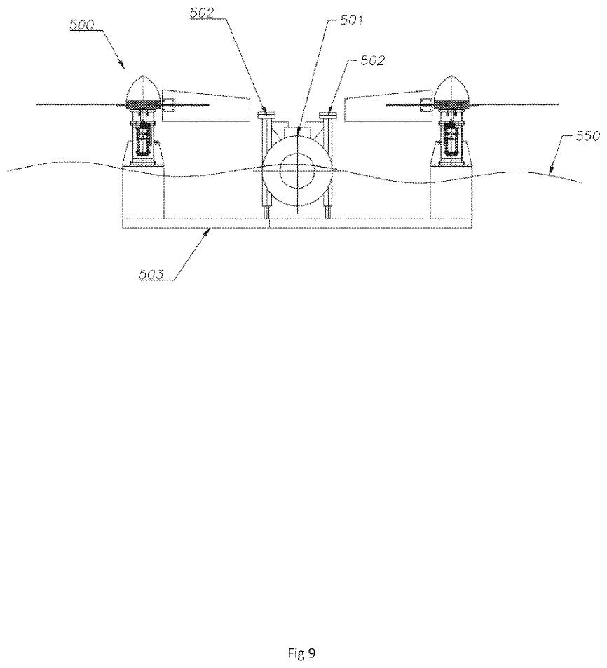

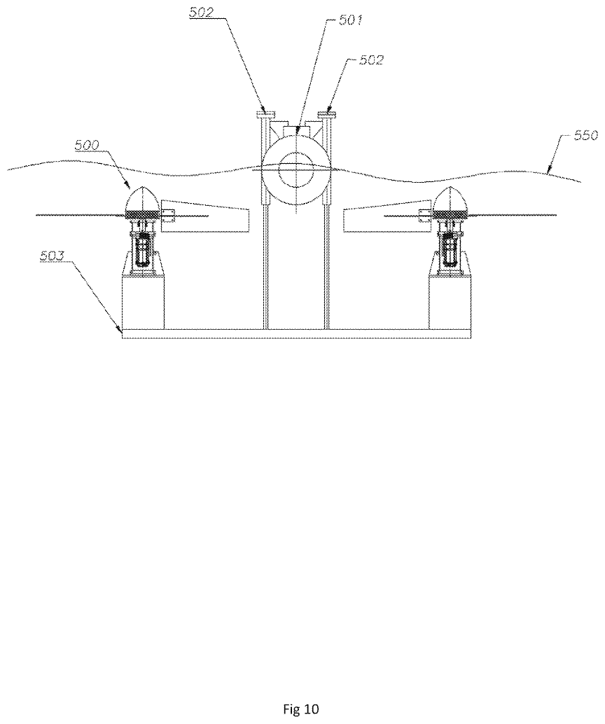

### Reference Will Now be Made to FIG. 8, FIG. 9 and FIG. 10

A floating hull (501) intended to float on top of a body of water (550) is fitted with two current turbines (500).

Hydraulic actuators (502) typically four, fixed to the floating hull (501) intend to lower the platform (503) into the body of water (550) to interact with the flow.

FIG. 9 shows the front elevation of the embodiment of the invention and FIG. 10 shows the platform (503) lowered by means of the hydraulic actuators (502).

Conventional mooring of the floating hull (501) with standard mooring chains and anchor

### Brief Principle of Operation

As shown in FIG. 2, the current flow (100), impinges onto the blade (15) on both sides of the primary shaft (3).

Looking at FIG. 3, the area of the blade (15) above the centerline axis of the blade support shaft (16) is more than below it. This difference in area causes a different load on either side of the blade support shaft (16). This causes this blade support shaft (16) to rotate in an anticlockwise direction. The torque transfer stud (17) also rotates with the blade support shaft (16) and stops when it hits the torque disc (19) and the torque transfer block (18). The blade (15) is in a vertical plane and carries with it the load imposed by the current flow (100)

Simultaneously, on the other side of the primary shaft (3), given the position of the torque transfer stud (17) and the differentia area presented by the blade (15) to the same direction of current flow (100), caused the blade (15) along with the blade support shaft (16) to rotate in a clockwise direction and the torque transfer stud now reverses and thus the blade (15) on this side presents a much narrower area to the current flow (100).

Thus, the differential force now generated on either side of the primary shaft (3) causes an overall rotation of the primary shaft (3) along its central axis.

As the rotation now rotates the blade (15), the new position, causes the blade (15) to rotate such that it presents a vertical face to the current flow (100), thus the differential torque is maintained, and rotation is continuous with respect to the current flow (100).

As submerged operation is expected, mechanical seals (13) are provided that prevents the external environment from entering the secondary casing (2) and the primary casing (1).

In other preferred embodiments of the invention a single gearbox (6) may be used.

In another embodiment of the invention the permanent magnet generator (12) along with the gearbox (6) to be placed onto a floating body (201). This arrangement will ensure that these components are not in a submerged environment and does not need mechanical seals to keep the liquids out.

In another embodiment of the invention, in order to completely eliminate the use of mechanical seals (13), the use of a magnetic coupling that transfers the rotational torque of the torque plate (19) to the primary shaft (3) is made use of.

All materials in contact with the water or seawater is made in a corrosion resistant alloy.

Where the torque transfer stud (17) impinges on the torque disc (19) a rubber pad or similar material can be used to absorb any shock and to reduce noise. Several such torque transfer stud (17) can be used along the blade support shaft (16).

The differential torque along the blade support shaft (16) along with the differential torque generated on opposite sides of the primary shaft (3) contributes to the operation of the turbine.

In another embodiment of the invention, the permanent magnet generator (12) can be replaced with a pump, such that should the water body be a river, the river water itself could be pumped to a place of need.

In another embodiment of the invention, the permanent magnet generator (12) can be replaced with conventionally excited generator.

1. An underwater current turbine for generating electrical power from water flow, essentially comprising:
a blade support shaft, comprising a blade fixed such that said blade position offers different areas around the longitudinal axis of the said blade support shaft;
said blade shaft a fixed to a minimum of two bearing housings with the said bearing housings being fixed to a torque disc;
a minimum of two torque transfer studs being fixed to the portion said blade support shaft being fixed between said bearing housings;
a minimum of two torque transfer block being fixed to the said torque disc;
a minimum of three of the said blade support shafts being positioned around the area of the said torque disc;
a casing assembly, containing a plurality of gearbox, generator;
a primary shaft with first end connected to the gearbox with the second end to the said torque disc;
said primary shaft provided with collar to transfer thrust to a thrust bearing being fixed to a thrust disc;
a seal spool housing a mechanical seal is fixed on to the said thrust disc;

2. As per claim 1, a current turbine for generating electrical power from water flow, but with the said casing being not underwater and being fixed to a floating body and with said casing assembly being horizontal.

3. As per claim 1, the said mechanical seal being replaced by permanent magnets being fixed on to said primary shaft and to the drive collar with said drive collar first being fixed to thrust bearing and the second end of the said drive collar being fixed to the said torque disc and a containment shell being placed between the said primary shaft and the said drive collar.

4. A renewable energy device as per claim 1 but with the permanent magnet or externally excited generator and the gearbox suitable for underwater/submersible application.

5. A renewable energy device as per claim 1 but with the blades inflated or deflated by an external or internal medium enabling a shape change.

6. As per claim 1, but with the said floating body being provided with a flow accelerator.

7. As per claim 4, with the said accelerator being provided with a slot being made on the said accelerator side and the said slot being covered with a rubber curtain.

8. As per claim 5, two current turbines being fixed to a platform, placed on either side's of a floating hull, with the said floating hull being provided with a minimum of two hydraulic actuators with one end of said hydraulic actuators fixed to the floating hull and the second end to said platform.

9. A renewable energy device as per claim 1 but with multiple number of assemblies containing the blades.

10. A renewable energy device as per claim 1 but with number of blades per assembly.

11. A renewable energy device as in the above claim 1, but with one side of the blades being completely lifted/not exposed to the oncoming current or wave.
